(19) United States
(12) Patent Application Publication
(10) Pub. No.: US 2022/0205830 A1
(43) Pub. Date: Jun. 30, 2022

(54) SECRET SCALE AND METHOD OF USE THEREOF

(71) Applicants: Marissa Miccio, Bayside, NY (US); Chayakrit Krittanawong, Houston, TX (US)

(72) Inventors: Marissa Miccio, Bayside, NY (US); Chayakrit Krittanawong, Houston, TX (US)

(21) Appl. No.: 17/646,501

(22) Filed: Dec. 30, 2021

Related U.S. Application Data
(60) Provisional application No. 63/199,457, filed on Dec. 30, 2020.

(51) Int. Cl. G01G 19/414; G01G 19/44; G01G 23/18

(52) U.S. Cl. CPC G01G 19/414; G01G 23/18; G01G 19/44

(57) ABSTRACT

A scale that is generally configured to let an individual know if they are losing weight, gaining weight or remaining the same weight on a daily basis without displaying the individual's weight. The scale can compare multiple weight values including a baseline weight, subsequent weighs and the present weight of an individual and display by graphics, text, sound or the like if the individual is losing weight, gaining weight or remaining the same weight.

### CROSS-REFERENCE TO RELATED APPLICATION

This patent application claims priority to U.S. Provisional Patent Application No. 63/199,457, filed Dec. 30, 2020, which is hereby incorporated by reference in its entirety as part of the present disclosure.

### FIELD OF THE INVENTION

The present disclosure relates generally to a device configured to assist with measuring weight of an individual and more specifically to a scale that is configured to track an individual's weight without ever displaying a numerical value of the individual's weight.

### BACKGROUND OF THE INVENTION

Daily self-weighing is crucial for public health intervention. Recent estimates indicate that at least 58% of the world's adult population will be overweight (BMI 25 to 29.9 kg/m²) and obese (BMI over 30 kg/m²) by 2030, while over 85% of adults in the United States will be overweight and obese by 2030. Overwhelming evidence, including clinical trials and meta-analyses, suggest that daily self-weighing has been associated with weight loss, particularly in individuals who reported self-weighing daily over a period of several months. Most importantly, study show that daily self-weighing and daily weight-based diuretic self-adjustment was associated with lower risks of heart failure-related emergency room visits or hospitalizations. In the 2013 American College of Cardiology Foundation (ACCF)/American Heart Association (AHA) Guideline for the Management of Heart Failure, adjusting the diuretic dosage based on weight increases or decreases beyond a specified range is reasonable in heart failure patients. However, weight displayed on a scale in individuals, particularly those with overweight, obesity, depression, anxiety, or eating disorders, and anxiety, could potentially worsen psychological states.

Traditional scales that are typically used to obtain and display the weight of an individual or object are well known. Such scales commonly include a digital or mechanical display that indicates the weight of an individual or object that is placed thereon.

Scales that do not display an individual's weight are also known. For example, one such scale is disclosed in U.S. Pat. No. 10,347,152. However, U.S. Pat. No. 10,347,152 allows for an individual's weight to be displayed as well as analyzes data based on user input and requires the interaction with an app on a smartphone, tablet or the like to display or project data as opposed through a scale directly. The scale disclosed in U.S. Pat. No. 10,347,152 is not user friendly, does not help set goals, does not easily track an individual's progress and only displays changes from baseline irregularly and displays weekly using color scale.

### SUMMARY OF THE INVENTION

The present disclosure relates generally to a self-weighing device/scale that is configured to record, but not display, the weight of an individual or object placed thereon and can be used as an isolated device or combined with other behavioral programs to facilitate individual's weight loss without adverse psychological events (e.g., anxiety, depression or eating disorders). The scale is designed for individual's that may be self-conscious about their weight and do not want their weight displayed on a scale, but want to lose or maintain their current weight. The primary objective to encourage individuals to lose weight with minimization of adverse psychological events (e.g., anxiety, depression or eating disorders) and provide engagement and compliance for daily self-weighing until goal reached. This scale should not be limited to individuals looking to lose weight or overweight individuals, but the scale can be used by individuals that may want to gain weight (e.g., pregnancy, psychological disorders, etc.) or maintain their current weight.

Through various forms of social media, print media, television, etc., individuals are constantly being told that they should be a certain weight and seeing a number that may be higher than the individual wants to weigh or a higher number that they weighed on a display of a scale can be discouraging. Because of this, some individuals choose to not weigh themselves on a regular basis and as a result are uncertain if they are gaining, maintaining or losing weight. Also, for individuals that have not stepped on a scale in a long time, they may not want to out of fear that they will see a number higher than they wanted. However, without weighing yourself on a regular basis it is hard to track an individual's weight.

In an embodiment, the scale is generally configured to let an individual know if they are losing weight, gaining weight or remaining the same weight on a daily basis without displaying the individual's weight. The scale can compare multiple weight values including a baseline weight (a first weigh in by an individual), the prior weight of an individual and the present weight of an individual.

During an initial weigh-in, an individual's baseline weight can be recorded. This can be indicated, for example, with the scale displaying the word baseline, illuminating a certain color light source, displaying a sign(s) or an emoji icon(s), making a sound or verbally indicating as such through a speaker. The second time the individual steps onto the scale, the scale can compare the individual's current weight with their baseline weight without displaying either numerical value. Rather, the scale can indicate if the individual gained weight, lost weight or remained the same weight by other means. For example, if the individual gained weight from the initial baseline weigh-in, the scale can say and/or display the greater than symbol (i.e., >), an emoji (e.g., an unhappy emoji) or similar to indicate a weight increase. If the individual lost weight from the initial baseline weigh-in, the scale can say and/or display the greater than symbol (i.e., <), an emoji (e.g., a happy emoji) or similar to indicate a weight decrease. For subsequent weigh-ins, if the individual gained weight from the initial baseline weigh-in and a previous weigh-in, the scale can display the greater than symbol (i.e., >), a specific emoji (e.g., unhappy emoji), or similar to indicate a weight increase for the current weigh-in. If the individual lost weight from the initial baseline weigh-in and a previous weigh-in, the scale can say and/or display the less than symbol (i.e., <) or similar to indicate a weight decrease for the current weigh-in. If an individual lost weight after their last weigh in, but the individual weigh's more than their baseline weight, the scale can say and/or display “moving twd baseline,” (e.g., →baseline), a specific emoji (e.g., happy emoji), or similar. If an individual gained weight after their last weigh in, but the individual still weighs less than their baseline weight, the scale can say and/or display “moving twd baseline,” (←baseline), a specific emoji, (e.g., happy emoji) or similar. If there is no change in weight from previously a previously measured weigh-in, but weight the individual's weight is still greater than the individual's baseline weight, the scale can, for example, display and/or say no change (>), no change (>baseline), or specific emoji (e.g., unhappy emoji).

In another embodiment, the present disclosure is directed to a scale that is configured to compare only two weights, a baseline weight (first weigh-in) of an individual and the current weight of the individual. Here, when the individual first steps onto the scale, their weight can be recorded and the scale can project and/or display the word baseline to indicate that the initial weigh-in was successfully recorded. It is noted that the scale can project and/or display any other word, phrase, character, symbol, graphic, color, sound or the like or a combination thereof to indicate the initial weight of an individual was successfully recorded by the scale. However, the scale will not display the individual's weight. For all subsequent weigh-ins, the scale will compare the individual's current weight with their baseline weight and indicate if the individual is gaining or losing weight. For example, if the individual lost four pounds since their initial weigh-in, the scale can project/say and/or display −4, <, a happy emoji or similar. Contrarily, if the individual, for example, gained four pounds since their initial weigh-in, the scale can project and/or display +4, the symbol >, an unhappy emoji or similar.

Additionally, in this embodiment, the scale can provide a detailed evaluation to help in guiding an individual's dietary and/or physical activities/exercise choices/routine/diuretic self-adjustment. Several studies showed that self-weighing allows for greater awareness of how behaviors are impacting weight, resulting in greater self-efficacy, self-control, and self-initiated reinforcement. For example, the scale can inform the individual if they lost weight by performing a certain physical activity/exercise or eating certain food(s). If the individual has gained weight since their baseline weigh-in or after losing weight from their baseline weigh-in, the scale can indicate as such without displaying their current weight, but also indicating what, if any physical activity/exercise the individual was performing and/or what food(s) the individual was eating. That way the individual can better understand what exercises (if they are being performed) and what food(s), may not be aiding the individual in losing weight and by alerting the individual, adjustments to the individual's exercise and/or eating can be made.

In yet another embodiment, the present disclose is directed to a scale that can be configured so that more than one individual can use the scale. Here, the scale can contain separate on/off buttons for each user.

In yet a further embodiment, the present disclosure is directed to a scale that can be configured for an individual that may want to gain weight. The individual can enter the amount of weight that they want to gain.

In yet another embodiment, the scale can sync with an app on a mobile device to record and display everything that the scale can display. The app can track weight loss, weight gain, etc. so that an individual can view the app when not using the scale to track their progress.

In another embodiment, the present disclosure is directed to a method to promote weight change goals implemented in an electronic scale having a weight sensor, a graphical display, a digital memory, and a microprocessor in communication with the weight sensor, display, and memory, the method implemented using the microprocessor and comprising the steps of capturing using the weight sensor a current weight of the user; determining from a predefined set of weight change categories a particular weight change category as a function of the current weight of the user and values stored in the memory for a baseline weight of the user and a previous weight of the user; and displaying specific non-numeric indicia associated with the determined weight change category on the display.

The non-numeric indicia can comprise graphical icons, and the step of displaying can comprise selecting the specific non-numeric indicia from a predefined set of graphical icons stored in the memory.

The predefined set of weight change categories can comprise a weight maintaining category, a gaining weight category, a losing weight category, and a fluctuating weight category.

The predefined set of weight change categories can further comprise a goal reached category.

In yet another embodiment, the present disclosure is directed to a system for promoting weight change goals, comprising an electronic scale comprising weight sensor, a graphical display, a digital memory and a microprocessor in communication with the weight sensor, the display and the memory, the memory having data and computer instructions stored therein, the computer instructions configuring the processor to: capture using the weight sensor a current weight of the user; determine from a predefined set of weight change categories a particular weight change category as a function of the current weight of the user and values stored in the memory for a baseline weight of the user and a previous weight of the user; and display specific non-numeric indicia associated with the determined weight change category on the display.

The computer instructions can configure the processor to select as the specific non-numeric indicia a graphical icon from a predefined set of graphical icons stored in the memory, each graphical icon in the predefined set of graphical icons being associated with a respective weight change category.

The computer instructions can further configure the processor to capture using the weight sensor a baseline weight of a user and store the baseline weight in the memory.

The computer instructions can further configure the processor to, after the particular weight change category is determined, set the value of the previous weight of the user stored in the memory to the current weight of the user.

The computer instructions can further configure the processor to set an initial value for the previous weight of the user to the baseline weight.

The predefined set of weight change categories can comprise a weight maintaining category, a gaining weight category, a losing weight category, and a fluctuating weight category.

The computer instructions can configure the processor to determine the particular weight change category by: selecting the weight maintaining category if the current weight is substantially equal to the baseline weight or the current weight is substantially equal to the previous weight; selecting the gaining weight category if the current weight is substantially greater than both the previous weight and the baseline weight; selecting the losing weight category if the current weight is substantially less than the previous weight and the baseline weight; and selecting the fluctuating weight category if the current weight is substantially less than the previous weight and substantially more than the baseline weight or if the current weight is substantially greater than the previous weight but substantially less than the baseline weight.

The scale can further comprise a user interface, the predefined set of weight change categories further comprise a goal reached category, the computer instructions further configure the processor to receive as input through the user interface a target weight for the user, the target weight indicating one of an absolute weight or a weight differential relative to the baseline weight, and store the target weight for the user in the memory and determine the particular weight change category by selecting the goal reached category if the current weight is substantially equal to the target weight.

A summary of display symbols and/or prompts verbalized by the scale that can be incorporate into any embodiment can include, without limitation the following:

Baseline;

<; specific emoji, or −/+ (number);

Moving towards baseline (>), (→baseline), specific emoji, or −/+ (number);

>; specific emoji, or −/+ (number);

Moving towards baseline (>);

No Change (>); specific emoji, or −/+ (number);

Moving toward baseline (<); (←baseline), specific emoji, or −/+ (number); and

Moving toward baseline (>); specific emoji, or −/+ (number).

### BRIEF DESCRIPTION OF THE DRAWING

FIG. 1 is a top view of a scale according to an embodiment of the present disclosure;

FIG. 2 is a perspective view of a scale according to another embodiment of the present disclosure;

FIG. 3 is a legend of various non-numeric symbols that can be displayed on the scale of FIG. 1 or FIG. 2, according to an embodiment of the present disclosure;

FIG. 4 is a diagram of features of the scale of FIG. 1 or FIG. 2 and interaction therebetween according to an embodiment of the present disclosure;

FIG. 5 is a flow chart of how data is imputed and processed according to an embodiment of the present disclosure;

FIG. 6A is a schematic view of a scale according to an embodiment of the present disclosure;

FIG. 6B is a schematic view of a scale according to an embodiment of the present disclosure;

FIG. 6C is a schematic view of a scale according to an embodiment of the present disclosure;

FIG. 7 is a schematic view of a foot peddle according to an embodiment of the present disclosure; and

FIG. 8 is a flow chart of how the scale of FIG. 1 analyzes data over a period of time and outputs information to an individual according to an embodiment of the present disclosure.

### DETAILED DESCRIPTION OF ENBODIMENTS OF THE PRESENT INVENTION

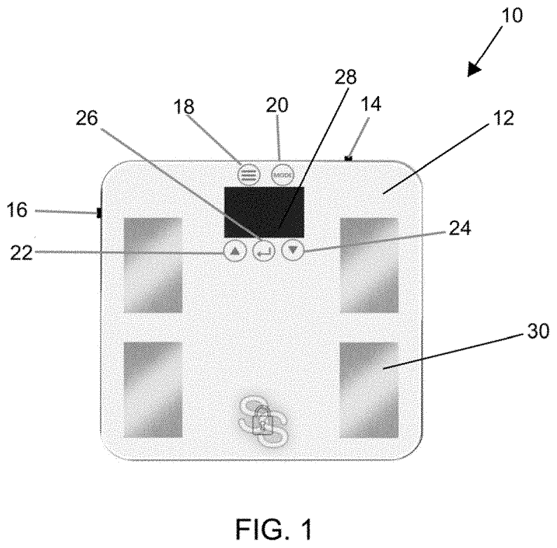

With reference now to the figures and in particular FIGS. 1-8, embodiments of a scale of the present disclosure will be described.

FIG. 1 illustrates an embodiment of a scale 10 that is configured to record but not display or project (e.g, through a prerecorded voice) a user's weight. Rather, the scale 10 is configured to record an initial weight of an individual by displaying “Baseline Weight Set” or the like or indicating a baseline weight is set through a visual (e.g., emoji), voice or by a sound and during subsequent weigh-ins indicate through visuals (e.g., emojis), voice, sounds or the like if the user is losing weight, gaining weight or maintaining the same weight.

The scale 10 includes a main body 12 that has an on/off button or switch 14, a user switch 16, a menu button 18, a mode button 20, an up-arrow button 22, a down arrow button 24, an enter button 26, a display screen (e.g., LCD screen) 28 and sensors 30 that are configured to detect the weight of a user. It is noted that while features of the scale 10 are arranged or located at specific positions on the main body 12 that the depiction should not limit the placement or number of features and the features can be arranged anywhere on the main body and in any form (e.g, button, switch, touch screen or button, etc.).

In an embodiment, after turning on the scale or the scale 10 automatically being activated by stepping there on, an individual can set a weight loss goal. This can be done by pressing the menu button 18, then using the down arrow button 24, highlight “Weight Loss Goal,” “How Much Weight Do You Want To Lose” or similar and pressing the enter button. Then using the up or down arrow until the weight loss number is reached and then pressing the enter button 26. The individual can the exist out of the menu by pressing the menu button 18. Alternatively, if the user wants to gain weight, the user can similarly use the menu button 18 and use the up arrow button 26 and highlight “Weight Gain Goal,” “How Much Weight do you want to Lose” or similar. The numerical value of weight lose gain can be increased exponentially if the up or down arrow button 24, 26 is held down.

The scale 10 can be used with multiple users. If there are more than one user, each user should be assigned a user designation such as a user number. Each user should make sure to switch to their user number each time they use the scale. This can be done, for example, by contacting the user button or switch 16 until the desire user's number or graphic display or the like is indicated on the scale.

Once the user elects to lose weight, gain weight or maintain their baseline weight, the user will then record their baseline weight which is the first time they use the scale. “Previous Weight” indicates the weight of a user the previous time they stepped on the scale. “Current Weight” indicate the current weight of the user.

Alternatively, or in addition to displaying the request to record a baseline weight of a user, the scale 10 may ask through a speaker (not shown) the same or a similar phrase to indicate the scale 10 is ready and wants to record a baseline weight of the user to track progress of the user's weight loss. The user can then step on the main body 12 so the scale 10 can record the user's baseline weight. The scale 10 can display the word “baseline” or “baseline weight recorded” to indicate the recording was captured by the scale 10. If the user elects for the scale 10 to be used so they individual can maintain their weight, the scale 10 may here similarly ask through the speaker the same or a similar phrase to indicate the scale 10 is ready and wants to record a baseline weight of the user to track progress of the user's weight loss. The scale 10 may say “record to record baseline” or similar and the user can then step on the main body 12 so the scale 10 can record the user's baseline weight. The scale 10 can display the word “baseline” or “baseline weight recorded” to indicate the recording was captured by the scale 10.

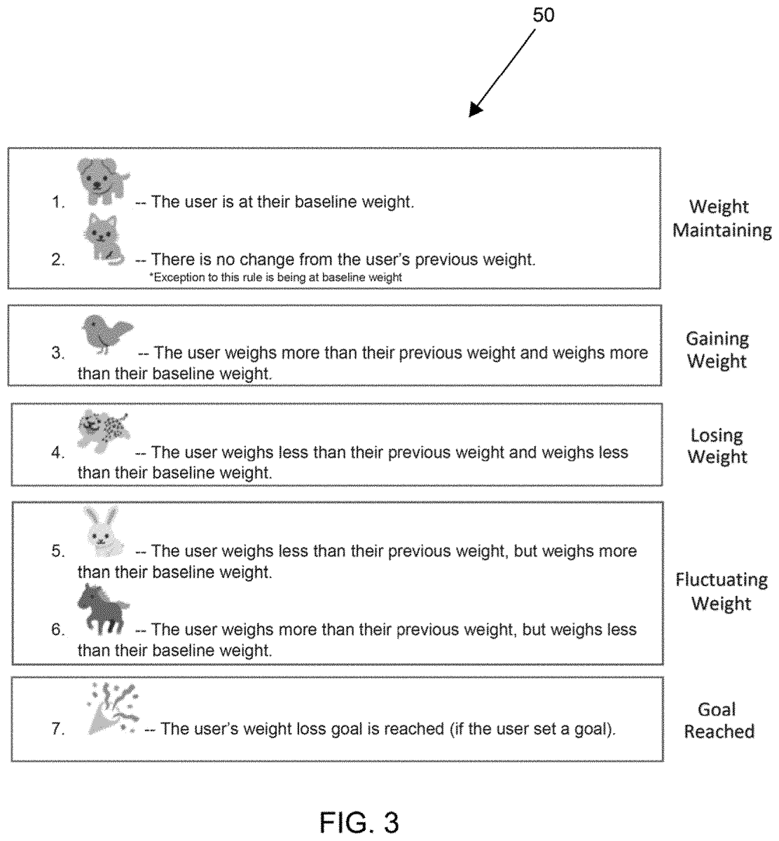

One mode that can be selected by a user is emoji mode whereby a graphic will be displayed upon an individual's weight recorded. This can be changed (or changed back to emoji mode) to by depressing the mode button. This mode compares the user's current weight to both the user's baseline weight and the user's previous weight. The user's current weight is then represented by an emoji. Such emojis are depicted in the legend 50 depicted in FIG. 3. As can be seen in the legend 50, for example, if the user maintains their weight, a dog emoji can be depicted or if there is no change from the user's previous weigh-in, a cat emoji is depicted. If the user gains weight, a bird emoji is depicted. If a user loses weight, a different emoji (e.g., a leopard) is depicted. Such emoji's and associated meanings should not be limiting as any other graphic, emoji (e.g., face emojis) or the like can be used to represent applicable indicators (i.e., weight loss, weight gain, etc.).

The scale 10 can alternatively be placed in a mode whereby numbers, but not the user's weight, are displayed. In this mode, the user's current weight is compared to their baseline weight. A positive number indicated that the user weighs more than their baseline weight while a negative number means the user weighs less than their baseline weight. For example, +4.0 means the user weighs 4.0 pounds more than their baseline weight and −4.0 means the user weighs 4.0 pounds less than their baseline weight. In an embodiment, the numerical value can be rounded to the nearest pound. A number will not be displayed is when a user is back at their baseline weight and instead “Baseline Weight” can be displayed or if a goal is set and reached. In that case, the scale can display, for example, “Goal Reached!”

If a set goal is reached, the scale can then ask the user to set a new baseline weight. If you want to lose more weight, the user would again set a weight loss goal again as indicated above by pressing the menu button, then using the down arrow button, highlight “Weight Gain Goal” and press the enter button. Then using the up or down arrow until the weight loss number is reached and then press the enter button. The individual can the exist out of the menu by pressing the menu button. If the user wishes to maintain their weight, a new goal does not have to be set.

To change the baseline weight at any time, press the menu button, use the down arrow to select “Baseline Weight”, press the enter button and then step on the scale.

The scale 10 can be reset by holding the menu button down and powering the scale on.

The scale 10 can be calibrated by holding the mode button while powering on the scale and then placing a known weight on the scale 10.

The scale 10 can turn off automatically after a period of time if not in use or the scale 10 can be manually turned off

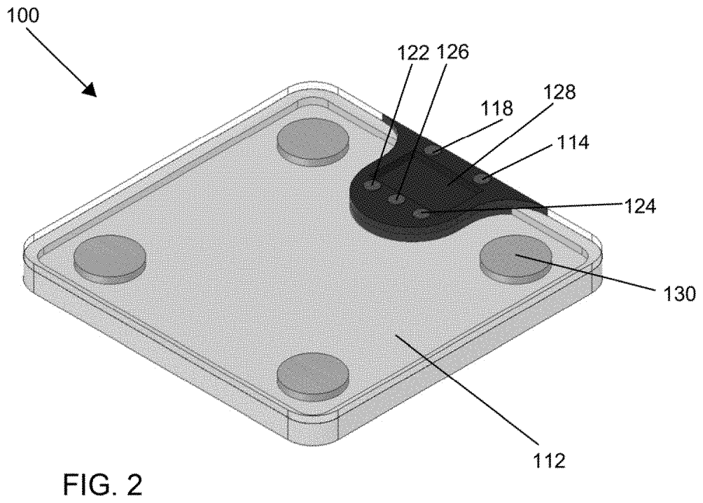

FIG. 2 depicts an embodiment of another scale 100 that is similar to the scale 10 with the exception being the placement of the buttons, switches and the like. As such, like reference numbers to scale 10 will be used in reference to scale 100. The scale 100 functions the same as the scale 10 and can be configured similar to the scale 10.

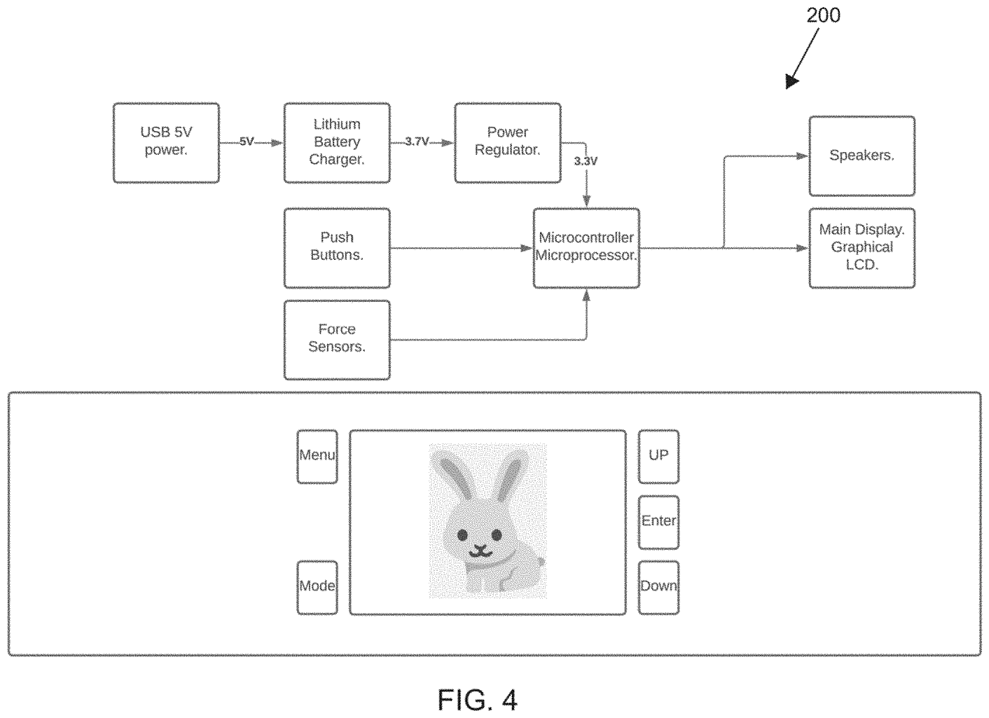

FIG. 4 is a flowchart 200 that outlines how the scale 10 is powered and the interaction from the power source to the microprocessor that interacts, for example with the buttons/switches, speakers, sensors, and the display.

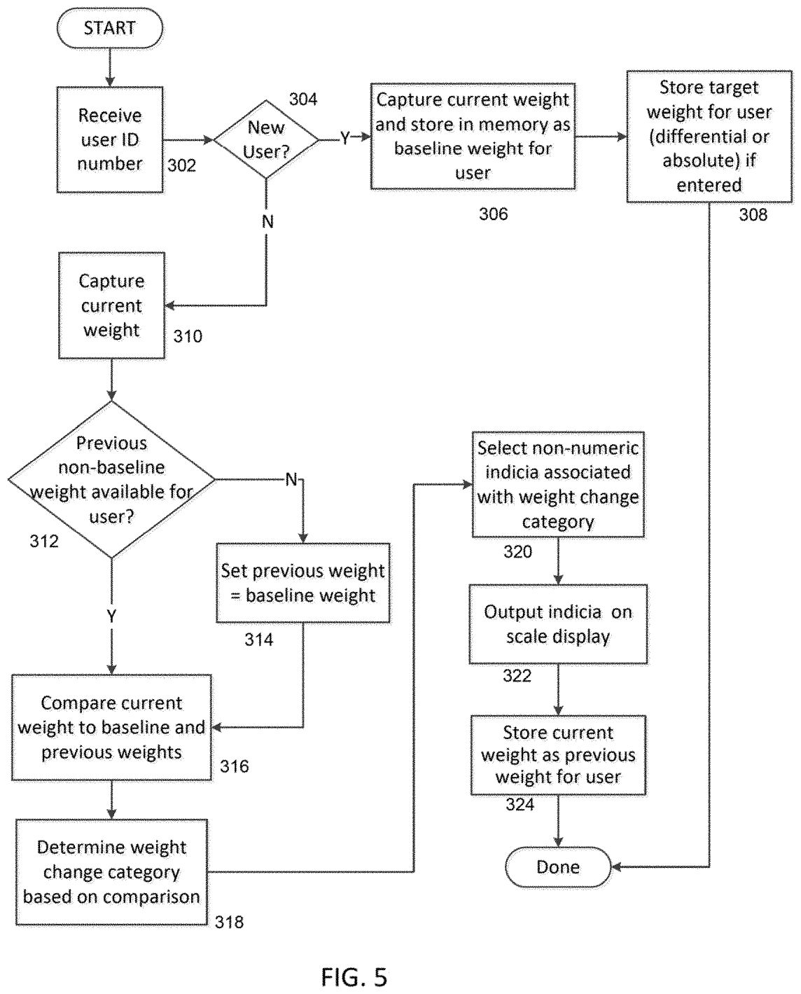

FIG. 5 is a high-level flow chart of the basic operation of an embodiment scale 10 as controlled by the processor in accordance with a computer program stored in memory. For configuration where multiple users can be programmed into the scale 10, the system can receive a user ID as entered by the user via the user interface, such control buttons on the scale 10 (Step 302). If a new user is indicated, such as when a new user ID number is received or the user has selected a New User option (step 304). The user's Current Weight is captured and stored in the memory as a Baseline Weight for that user (Step 306). A target weight can also be entered and stored for that user in the memory (Step 308). The target weight can be a specific goal weight or a desired amount of a weight increase or decrease, such as in pounds.

If a returning user is accessing the scale their current weight is captured (step 310). If this is only the second time the designated user has been weighed on the scale, only the Baseline Weight will be available for that user. In such a case, the initial value for a Previous Weight can be set equal to the Baseline Weight (Steps 312, 314). The initial value for the Previous Weight could also be set at different times, such as when the baseline weight is captured.

The Current Weight for the user is then compared to the Baseline and Previous Weight values to determine a weight change category (Steps 316, 318). Each weight change category has an associated non-numeric indicia that reflects how the user's Current Weight has changed relative to the Baseline and the Previous Weight. The non-numeric indicia associated with the weight change category is selected and output on the display (Steps 320, 322). Indicia can be in the form of graphical icons or text or symbols that can inform the user of their weight progress in a supportive manner but without indicating the user's actual weight. Various weight change categories and indicia are discussed herein. The user's Current Weight is then stored as the Previous Weight for use in a subsequent weighing session (Step 324).

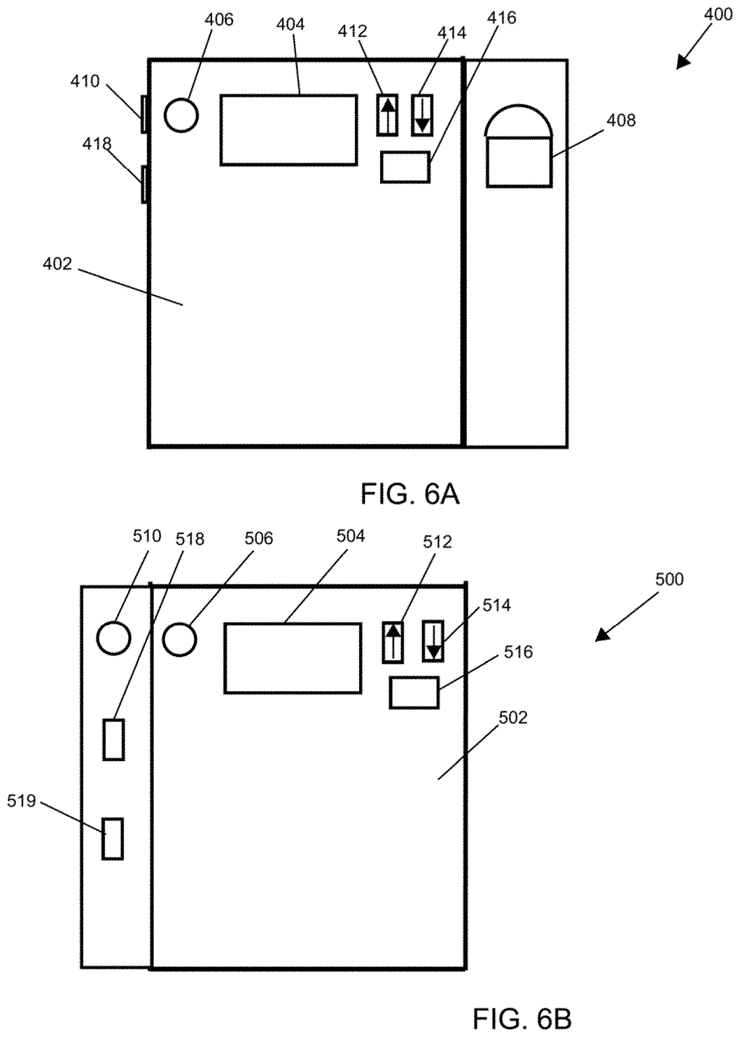

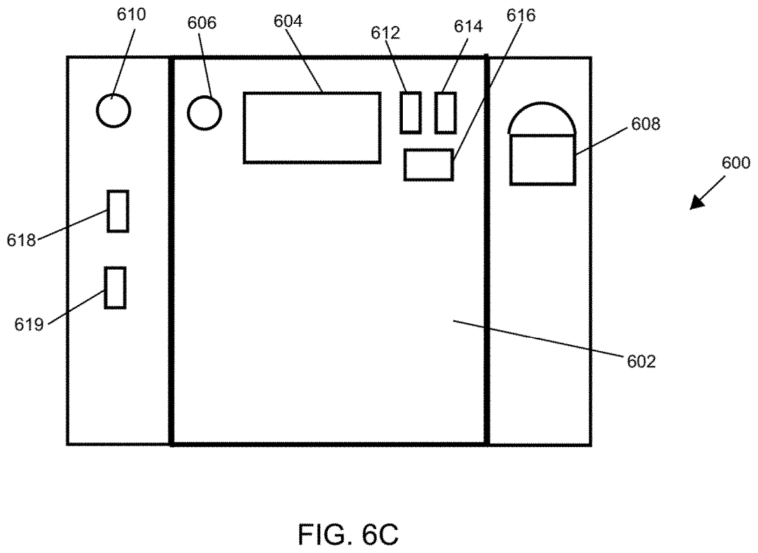

FIG. 6A illustrates another embodiment of a scale 400 according to the present disclosure that is configured to obtain the weight of an individual or object, but not display or project (e.g, through a prerecorded voice) the recorded weight. Like scales 10, 100, the scale 400 is configured to record an initial weight of an individual and during subsequent weigh-ins indicate through visuals, voice, sounds or the like if the individual is losing weight, gaining weight or maintaining the same weight. The features of scale 400 are the same as those of scales 10 and 100 and unless indicated otherwise an as such, like reference numbers to scales 10, 100 will be used in reference to scale 400.

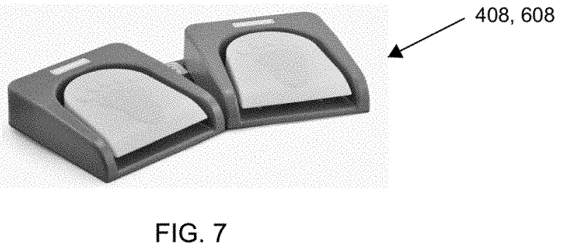

The scale 400 includes a main body 402 that has a display screen 404 and can include a plurality of buttons. To turn on or off the scale 400 a first on/off button 406 or a second on/off button, paddle or foot pedal 408 (see also FIG. 7) can be depressed. Alternatively, the scale 400 can be turned on automatically upon sensing the weight of an individual stepping on the scale 400. While the first on/off button 406 is configured to be depressed by an individual's hand and the second on/off button or pedal 408 is configured to be depressed by an individual's foot, both buttons 406, 408 can be depressed either by an individual's hand or foot. The first and second on/off buttons 406, 408 are interchangeable such that the individual can use the button 406 or 408 that they prefer to turn the scale 400 on and when not being used, off. Should the scale 400 need to be reset, a reset button 410 as shown in FIG. 1 can be depressed. However, it is noted that when the any of the buttons 406, 408, 410 are contacted, they may have to be held in a depressed state to allow the scale 400 to reset or startup.

FIG. 6B depicts an embodiment of another scale 500. The features of scale 500 are the same as those of scales 10, 100, 400 and unless indicated otherwise an as such, like reference numbers to scales 10, 100, 400 will be used in reference to scale 500. For example, 502 refers to the main body of the scale 500. The difference from the scale 400 of FIG. 7A is that select features or buttons such as the reset button 510, the button 518 that can be switched to depict a number or symbol, and a button 519 that can be depressed to turn sound on or off can be located on a sidewall of the scale 500 or another location on the body 502 of the scale 500. Additionally, the scale 500 removes the foot pedal option to turn the scale 400 on or off, making the scale 500 more compact.

FIG. 6C depicts another embodiment of a scale 600. The features of scale 600 are the same as those of scales 10, 100, 400, 500 and unless indicated otherwise an as such, like reference numbers to scales 10, 100, 400, 500 will be used in reference to scale 600. The difference from the scale 400 of FIG. 6A is that select features or buttons such as the reset button 610, the button 518 that can be switched to depict a number or symbol, and a button 619 that can be depressed to turn sound on or off can be located on a sidewall of the scale 600 or another location on the body 602 of the scale 600.

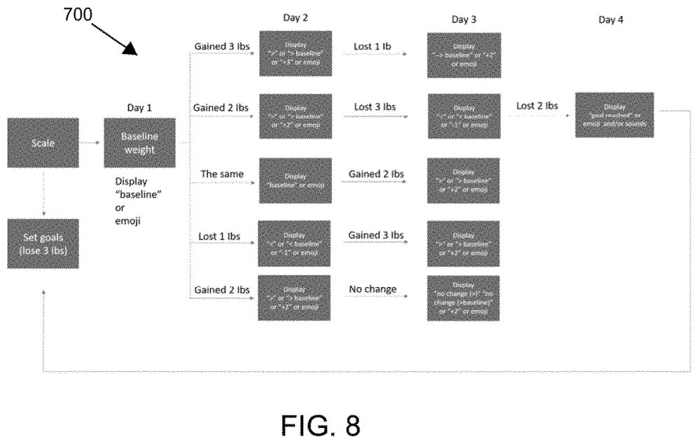

FIG. 8 is a flow chart 700 of how the scale of any of the above embodiments analyzes data over a period of time and outputs information to an individual.

In an embodiment, an app for the scale can be used to track weight loss, weight gain, etc. The app can sync with the scale so that all measurements, dates, and weigh recorded can be tracked on the app as well.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A method to promote weight change goals implemented in an electronic scale having a weight sensor, a graphical display, a digital memory, and a microprocessor in communication with the weight sensor, display, and memory, the method implemented using the microprocessor and comprising the steps of:
capturing using the weight sensor a current weight of the user;
determining from a predefined set of weight change categories a particular weight change category as a function of the current weight of the user and values stored in the memory for a baseline weight of the user and a previous weight of the user; and
displaying specific non-numeric indicia associated with the determined weight change category on the display.

2. The method of claim 1, wherein the non-numeric indicia comprises graphical icons, and the step of displaying comprises selecting the specific non-numeric indicia from a predefined set of graphical icons stored in the memory.

3. The method of claim 1, further comprising the steps of capturing using the weight sensor a baseline weight of a user and storing the baseline weight in the memory.

4. The method of claim 1, further comprising the step of, after the determining step, setting the value of the previous weight of the user to the current weight of the user.

5. The method of claim 1, further comprising the step of setting an initial value for the previous weight of the user to the baseline weight.

6. The method of claim 1, wherein the predefined set of weight change categories comprising a weight maintaining category, a gaining weight category, a losing weight category, and a fluctuating weight category.

7. The method of claim 6, further comprising the steps of receiving as input through a user interface on the scale a target weight for the user, the target weight indicating one of an absolute weight or a weight differential relative to the baseline weight; and storing the target weight for the user in the memory, the step of determining the particular weight change category being a further function of the target weight for the user.

8. The method of claim 7, wherein the predefined set of weight change categories further comprising a goal reached category.

9. A system for promoting weight change goals, comprising:
an electronic scale comprising weight sensor, a graphical display, a digital memory and a microprocessor in communication with the weight sensor, the display and the memory;
the memory having data and computer instructions stored therein, the computer instructions configuring the processor to:
capture using the weight sensor a current weight of the user;
determine from a predefined set of weight change categories a particular weight change category as a function of the current weight of the user and values stored in the memory for a baseline weight of the user and a previous weight of the user; and
display specific non-numeric indicia associated with the determined weight change category on the display.

10. The system of claim 9, wherein the computer instructions configure the processor to select as the specific non-numeric indicia a graphical icon from a predefined set of graphical icons stored in the memory, each graphical icon in the predefined set of graphical icons being associated with a respective weight change category.

11. The system of claim 9, wherein the computer instructions further configure the processor to capture using the weight sensor a baseline weight of a user and store the baseline weight in the memory.

12. The system of claim 9, wherein the computer instructions further configure the processor to, after the particular weight change category is determined, set the value of the previous weight of the user stored in the memory to the current weight of the user.

13. The system of claim 9, wherein the computer instructions further configure the processor to set an initial value for the previous weight of the user to the baseline weight.

14. The system of claim 9, wherein the predefined set of weight change categories comprise a weight maintaining category, a gaining weight category, a losing weight category, and a fluctuating weight category.

15. The system of claim 14, wherein the computer instructions configure the processor to determine the particular weight change category by:
selecting the weight maintaining category if the current weight is substantially equal to the baseline weight or the current weight is substantially equal to the previous weight;
selecting the gaining weight category if the current weight is substantially greater than both the previous weight and the baseline weight;
selecting the losing weight category if the current weight is substantially less than the previous weight and the baseline weight; and
selecting the fluctuating weight category if the current weight is substantially less than the previous weight and substantially more than the baseline weight or if the current weight is substantially greater than the previous weight but substantially less than the baseline weight.

16. The system of claim 15, wherein the scale further comprises a user interface, the predefined set of weight change categories further comprise a goal reached category, the computer instructions further configure the processor to receive as input through the user interface a target weight for the user, the target weight indicating one of an absolute weight or a weight differential relative to the baseline weight, and store the target weight for the user in the memory and determine the particular weight change category by selecting the goal reached category if the current weight is substantially equal to the target weight.
